(19) United States
(12) Patent Application Publication
(10) Pub. No.: US 2025/0223135 A1
(43) Pub. Date: Jul. 10, 2025

(54) METHOD AND ELEVATOR ARRANGEMENT

(71) Applicant: Kone Corporation, Helsinki (FI)

(72) Inventor: Juha HELENIUS, Helsinki (FI)

(73) Assignee: Kone Corporation, Helsinki (FI)

(21) Appl. No.: 19/040,259

(22) Filed: Jan. 29, 2025

Related U.S. Application Data
(63) Continuation of application No. PCT/FI2022/050615, filed on Sep. 13, 2022.

(51) Int. Cl. B66B 7/12

(52) U.S. Cl. CPC B66B 7/1215

(57) ABSTRACT

The invention relates to a method of monitoring condition of a rope of an elevator arrangement, the method comprising monitoring by a computer system an amount of bendings of each discretization point and/or of each discretization portion around a rope wheel during elevator use, the amount of bendings of each discretization point and/or of each discretization portion being indicated by a bending value associated with the discretization point and/or discretization portion in question; wherein each said discretization point is a point within a rope portion extending between successive contact positions of the rope, and respectively, each said discretization portion is a rope portion extending between successive contact positions of the rope; and wherein said contact positions of the rope include the positions of the rope, per each landing, which are contacted by rope wheels when the car is at the landing. The invention also relates to an elevator arrangement implementing the method.

### CROSS-REFERENCE TO RELATED APPLICATION

This application is a continuation of PCT International Application No. PCT/FI2022/050615 which has an International filing date of Sep. 13, 2022, the entire contents of which are incorporated herein by reference.

### FIELD OF THE INVENTION

The invention relates to a method of monitoring condition of a rope of an elevator arrangement and to an elevator arrangement. The elevator arrangement is preferably an elevator arrangement for transporting passengers and/or goods.

### BACKGROUND OF THE INVENTION

In elevators, the ropes connected to the elevator car are generally guided by rope wheels. The ropes pass around the rope wheel bending against the rim thereof. During car travel, the ropes connected to the car continuously run around the rope wheel. Any part of the rope that runs around the rope wheel undergoes a bending cycle, which involves bending into a curved shape and a subsequent straightening. The ropes normally endure without any damage hundreds of thousands, or even millions, bending-cycles. However, the ropes are not allowed to be used until they break. The ropes need to be monitored, maintained and replaced with new ones early before breaking so as to avoid hazardous situations. The need for maintenance or replacement of ropes has been determined either by visual inspection or by algorithms determining the amount of bendings undergone by different parts of a rope. One method according to prior art is disclosed in a patent document U.S. Pat. No. 9,643,816B2.

In general, the amount of bendings experienced by a point of a rope can be determined e.g. by counting or computing. The amount of bendings expressed as a bending value can reflect reality so that it is likely to bring out if the point of the rope is about to reach a critical amount of bendings. Thus, the amount of bendings can be used to deduce when to replace the rope with a new one. On the other hand, the counter or computer of the amount of bendings needs to be simple and not to consume much capacity of the devices performing the process, such as the processor capacity of the elevator control unit for example.

In general, complicated elevator arrangements which comprise plurality of rope wheels and for example suspension ratio 2:1 or 4:1, are likely to require complicated counters/computers. The number of times a given point of the rope experiences bendings per a journey depends on the number and position of rope wheels relative to the rope as well as on the landings between which the car travels in the journey. Different journeys bend different points of the rope, and some journeys are more frequent than others.

It would be advantageous if there was a simple and minimalistic way to monitor the amount of bendings in rope positions which are likely most critical in terms of the amount of bendings they have experienced during elevator use.

### BRIEF DESCRIPTION OF THE INVENTION

The object of the invention is to introduce an improved method of monitoring condition of a rope of an elevator arrangement and to an improved elevator arrangement. An object is particularly to introduce a solution by which one or more of the above-mentioned problems of prior art and/or drawbacks discussed or implied elsewhere in the description can be alleviated. An object is particularly to introduce a solution where elevator operation can be ensured simply with regard to rope condition.

It is introduced, inter alia, embodiments which provide a simple and minimalistic way to monitor the amount of bendings in rope positions which are likely most critical in terms of the amount of bendings they have experienced during elevator use. The introduced solutions also facilitate utilizing a light computer system for the monitoring.

It is brought forward a new method of monitoring condition of a rope of an elevator arrangement, which elevator arrangement comprises an elevator car;
at least one rope connected to the elevator car;
a plurality of landings; and
a plurality of rope wheels around which the rope passes; and
a computer system for monitoring condition of the rope;
the method comprising
monitoring by the computer system an amount of bendings of each discretization point and/or of each discretization portion around a rope wheel during elevator use, the amount of bendings of each discretization point and/or of each discretization portion being indicated by a bending value associated with the discretization point and/or discretization portion in question;
wherein each said discretization point is a point within a rope portion extending between successive contact positions of the rope, and respectively, each said discretization portion is a rope portion extending between successive contact positions of the rope; and
wherein said contact positions of the rope include the positions of the rope, per each landing, which are contacted by rope wheels when the car is at the landing.

With the new method one or more of the above-mentioned objects can be facilitated.

Preferable further details of the method are introduced in the following, which further details can be combined with the method individually or in any combination. The further details further facilitate one or more of the above-mentioned objects.

In a preferred embodiment, the method comprises,
determining contact positions of the rope, comprising determining per each landing, the positions of the rope, which are contacted by rope wheels when the car is at the landing; and
determining discretization points or discretization portions of the rope, such that each discretization point is a point within a rope portion extending between successive contact positions or respectively each discretization portion is a rope portion extending between successive contact positions.

In a preferred embodiment, the contact positions are determined such [or are regarded to be such) in particular that there is only one contact position per the length of contact between the rope and the rope wheel.

In a preferred embodiment, the monitoring comprises
comparing, in particular by the computer system for monitoring condition of a rope, each bending value with at least one limit value; and
performing, in particular by a computer system for monitoring condition of a rope, one or more actions if any of the bending values meets a limit value.

In a preferred embodiment, the method comprises associating with each said discretization point or a discretization portion respectively (determined in said determining) a different memory position in a memory for storing a bending value of a discretization point or a discretization portion.

In a preferred embodiment, the monitoring comprises counting or computing a bending value for each discretization point and/or of each discretization portion.

In a preferred embodiment, the counting is performed during elevator use, e.g. continuously, and/or the computing is performed intermittently or after a period of elevator use, e.g. based on stored elevator journey data.

In a preferred embodiment, the counting or the computing a bending value comprises increasing a bending value in a memory position which is associated with a discretization point or a discretization portion respectively, by a value, preferably 1, per each time said discretization point or a discretization portion respectively passes, or has passed, around a rope wheel during a car journey from one landing to another.

In a preferred embodiment, the method comprises determining for each car journey which discretization points, or discretization portions respectively, pass, or have passed, around a rope wheel during the car journey in question and/or the memory positions the values of which are to be increased.

In a preferred embodiment, said determining for each car journey the memory positions the values of which are to be increased comprises retrieving from a database, such as a table, information indicating the memory positions the values of which are to be increased for the journey in question. The database then preferably comprises information indicating the memory positions the values of which are to be increased for each possible journey variation.

In a preferred embodiment, said determining for each car journey which discretization points or discretization portions respectively pass, or have passed, around a rope wheel during the car journey in question is performed by computing. The result of this determining can provide the memory positions the values of which are to be increased as mentioned above.

In a preferred embodiment, the contact positions and/or said discretization points are presented and/or processed as a value representing distances of the contact positions and/or said discretization points along the rope length from a rope reference position, said rope reference position preferably being an end point of the rope or the contact point which is first from an end point of the rope.

In a preferred embodiment, each said discretization point is within central third of the rope portion extending between successive contact positions, most preferably the middle point of the portion.

In a preferred embodiment, the determining discretization points or discretization portions of the rope comprises arranging the values of the contact positions in order of magnitude, and selecting a value of each discretization point such that it is between values of successive contact positions, or respectively selecting value range of each discretization portion such that the range is between values of successive contact positions.

In a preferred embodiment, the hoisting rope is connected to the car via at one or more rope wheels mounted on the car.

In a preferred embodiment, said plurality of rope wheels comprises one or more rope wheels mounted on a counterweight, one or one or more rope wheels mounted in a stationary location, comprising preferably a drive wheel, and one or more rope wheels mounted on the car, the rope preferably passing around them in this order.

In a preferred embodiment, the computer system comprises one or more processors, such as microprocessors.

In a preferred embodiment, the computer system is integral with an elevator control unit comprised in the arrangement or alternatively the computer system can be remote from the elevator control unit, in which case it is preferably connected to the control unit via a data transfer network or data transfer bus.

It is also brought forward a new elevator arrangement comprising an elevator car;
at least one rope connected to the elevator car;
a plurality of landings; and
a plurality of rope wheels around which the rope passes; and
a computer system for monitoring condition of the rope, the computer system comprising a memory having plurality of memory positions for storing a bending value of a discretization point or a discretization portion (p1-p15), wherein with each of said memory positions a discretization portion or a discretization point has been associated, wherein the computer system is configured to
monitor an amount of bendings of each discretization point and/or of each discretization portion around a rope wheel during elevator use, the amount of bendings of each discretization point and/or of each discretization portion being indicated by a bending value associated with the discretization point and/or discretization portion in question;
wherein each said discretization point is a point within a rope portion extending between successive contact positions of the rope, and respectively, each said discretization portion is a rope portion extending between successive contact positions of the rope; and
wherein said contact positions of the rope include the positions of the rope, per each landing, which are contacted by rope wheels when the car is at the landing.

With the new arrangement one or more of the above-mentioned objects can be facilitated.

Preferable further details of the arrangement are introduced in the following, as well as such details have also been introduced earlier above, which further details can be combined with the arrangement individually or in any combination. The further details further facilitate one or more of the above-mentioned objects.

In a preferred embodiment, the computer system is configured to
compare each bending value with at least one limit value; and
perform one or more actions if any of the bending values meets a limit value.

In a preferred embodiment, the computer system is configured to count or compute a bending value for each discretization point and/or for each discretization portion.

In a preferred embodiment, the computer system is configured to perform said counting during elevator use, e.g. continuously and/or to perform said computing intermittently or after a period of elevator use, e.g. based on stored elevator journey data.

In a preferred embodiment, the computer system is configured to perform said counting and/or computing by a computer program stored in the memory and running in said computer system.

In a preferred embodiment, the computer system is configured to, in particular by the computer program, to increase a bending value in a memory position which is associated with a discretization point or a discretization portion respectively, by a value, preferably 1, per each time said discretization point or a discretization portion respectively passes, or has passed, around a rope wheel during a car journey from one landing to another.

In a preferred embodiment, the computer system is configured to, in particular by a computer program, determine for each car journey which discretization points, or discretization portions respectively, pass, or have passed, around a rope wheel during the car journey in question and/or to determine the memory positions the values of which are to be increased.

Generally, the car preferably comprises an interior wherein passenger and/or goods can be transported. The car preferably also comprises one or more doors by which the interior can be opened and closed. The door is preferably an automatic door, whereby comfortable and safe elevator use can be provided by the elevator solution.

### BRIEF DESCRIPTION OF THE DRAWINGS

In the following, the present invention will be described in more detail by way of example and with reference to the attached drawings, in which

FIG. 1 illustrates an elevator arrangement according to an embodiment implementing a method according to an embodiment wherein the car is at landing 3a.

FIG. 2 illustrates the elevator arrangement of FIG. 1 wherein the car is at landing 3b.

FIG. 3 illustrates the elevator arrangement of FIG. 1 wherein the car is at landing 3c.

FIG. 4 illustrates the elevator arrangement of FIG. 1 wherein the car is at landing 3d.

FIG. 5 illustrates a table presenting contact positions of the elevator arrangement of FIG. 1 in numerical form as a distance along the rope length from a rope reference position.

FIG. 6 illustrates a table presenting discretization points between successive contact positions of FIG. 5.

FIG. 7a illustrates where the rope wheels contact the rope as well as where contact positions A1-D1 are along the rope length from a rope reference position, when the car is at landing 3a and positioned as illustrated in FIG. 1.

FIG. 7b illustrates where the rope wheels contact the rope as well as where contact positions A2-D2 are along the rope length from a rope reference position, when the car is at landing 3b and positioned as illustrated in FIG. 2.

FIG. 7c illustrates where the rope wheels contact the rope as well as where contact positions A3-D3 are along the rope length from a rope reference position, when the car is at landing 3c and positioned as illustrated in FIG. 3.

FIG. 7d illustrates where the rope wheels contact the rope as well as where contact positions A4-D4 are along the rope length from a rope reference position, when the car is at landing 3d and positioned as illustrated in FIG. 4.

FIG. 7e illustrates the rope and where contact positions, and discretization points are along the rope length from a rope reference position.

FIG. 8 illustrates schematically an example of amount of bendings of different discretization points and amount of actual bendings of different points of the rope and the amount of bendings of contact positions for comparison of different ways to monitor amount of bendings.

FIG. 9 illustrates by diagonal broken lines, from where and to where, each rope wheel has rotated along the rope in a case where a journey of the car is from landing 3b to landing 3c, i.e. between car positions as illustrated in FIGS. 2 and 3.

FIG. 10 illustrates the amount of bendings of each discretization point per journey of the car from landing 3b to 3c as analyzed in FIG. 9.

### DETAILED DESCRIPTION

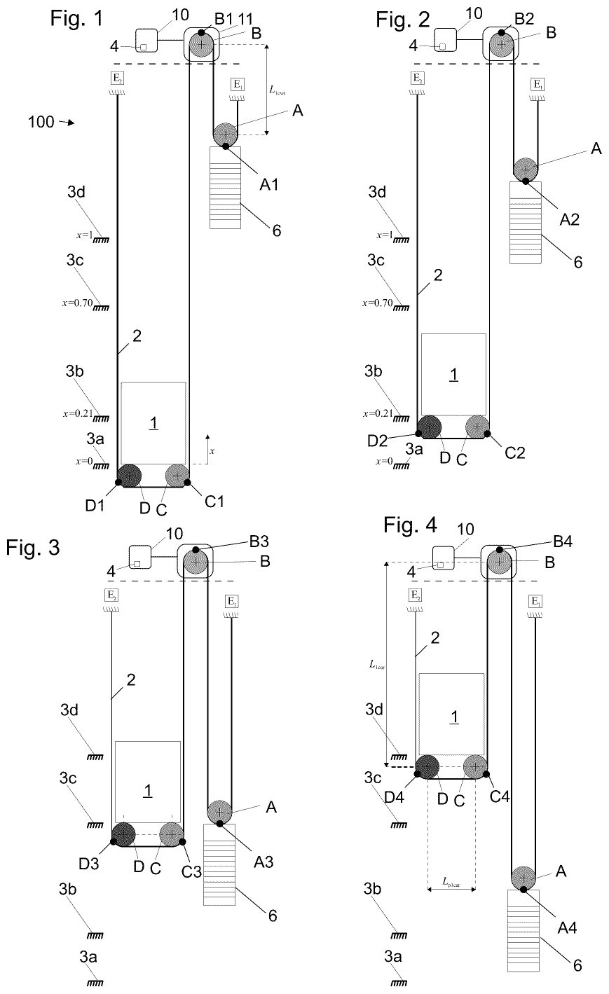

FIG. 1 illustrates an elevator arrangement 100 according to an embodiment implementing a method according to an embodiment. The elevator arrangement 100 comprises an elevator car 1, at least one rope 2 connected to the elevator car 1 and plurality on of landings 3a-3d. The elevator car 1 can be driven vertically to be positioned at any of the landings 3a-3d. In the elevator arrangement 100 of FIG. 1, there are four landings 3a-3d. The elevator arrangement 100 could have alternatively more or less landings than illustrated. When at a landing 3a-3d, the car sill is level with a sill of the landing. The elevator arrangement 100 comprises a plurality of rope wheels A,B,C,D around which each of said at least one rope 2 passes. During use of the elevator arrangement 100, i.e. during its use for transporting passengers and/or goods, the elevator car 1 travels vertically between landings. During car travel, each said rope 2 connected to the car 1 continuously runs around the rope wheels A,B,C,D. Any part of the rope 2 that runs around a rope wheel undergoes a bending, also referred to as a bending cycle, which involves bending into a curved shape and a subsequent straightening.

The elevator arrangement 100 comprises a computer system 4 for monitoring condition of each said rope 2. The computer system 4 can be integral with an elevator control unit 10 comprised in the arrangement 100, as illustrated in FIG. 1, or alternatively computer system 4 can be remote from the elevator control unit 10, in which case it is preferably connected to the control unit 10 via a data transfer network or data transfer bus. In the case the computer system 4 is remote, it may be positioned e.g. elsewhere than the building where the elevator car 1 travels. As illustrated in FIG. 1, the aforementioned control unit 10 is preferably connected with an electric motor 11 for rotating the drive wheel B of the arrangement 100, whereby the control unit 10 can control rotation of the motor 11 and thereby also rotation of the drive wheel B and thereby also movement of the rope 2. The control unit 10 is preferably configured to control movement of the car 1 between landings, by controlling rotation of the motor 11, based on signals received from one or more user interfaces located at one or more landings 3a-3d and/or inside the car 1.

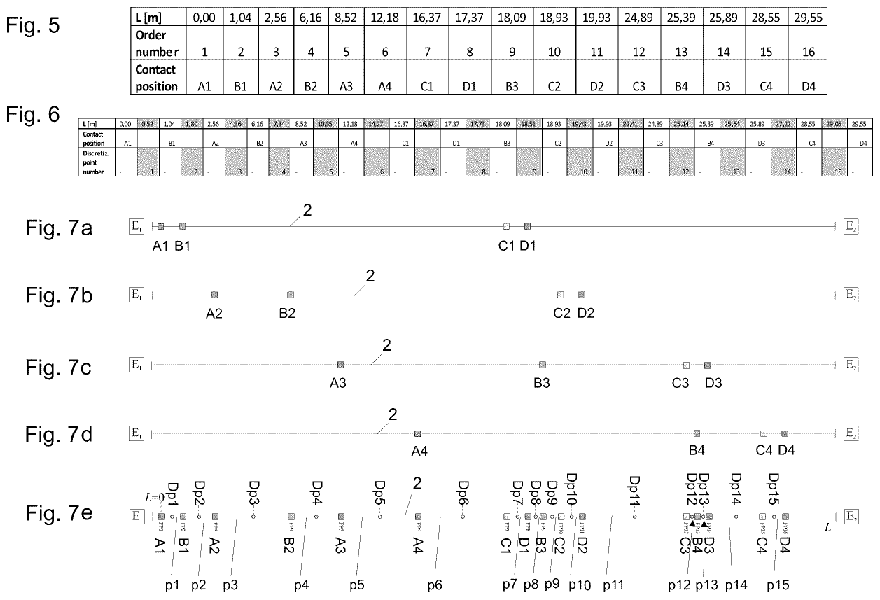

FIG. 1 illustrates the elevator car 1 at the landing 3a, which is the lowermost landing. A position A1 of the rope 2, later referred to as a contact position A1, is contacted by a rope wheel A, which is in the illustrated case a rope wheel mounted on a counterweight 6. A position B1 of the rope 2, later referred to as a contact position B1, is contacted by a rope wheel B, which is in the illustrated case a drive wheel mounted stationary relative to the building in which the car 1 is arranged to travel. A position C1 of the rope 2, later referred to as a contact position C1, is contacted by a rope wheel C, which is in the illustrated case a first rope wheel mounted on the car 1. The drive wheel B is rotatable by an electric motor 11 comprised in the arrangement 100. A position D1 of the rope 2, later referred to as a contact position D1, is contacted by a rope wheel D, which is in the illustrated case a second rope wheel mounted on the car 1. The contact positions A1-D1 are showed in FIG. 7a, showing the rope 2 in straight shape, as well as in FIG. 5 presenting the contact positions A1-D1 in numerical form as a distance along the rope length from a rope reference position, said rope reference position being in this case the contact position A1.

FIG. 2 illustrates the elevator car 1 at landing 3b, and contact positions A2-D2 contacted by the rope wheels A-D. The contact positions A2-D2 are showed in FIG. 7b, showing the rope 2 in straight shape, as well as in FIG. 5 presenting the contact positions A2-D2 in numerical form as a distance L along the rope length from the aforementioned rope reference position.

FIG. 3 illustrates the elevator car 1 at landing 3c, and contact positions A3-D3 contacted by the rope wheels A-D. The contact positions A3-D3 are showed in FIG. 7c, showing the rope 2 in straight shape, as well as in FIG. 5 presenting the contact positions A3-D3 in numerical form as a distance L along the rope length from the aforementioned rope reference position.

FIG. 4 illustrates the elevator car 1 at landing 3d, and contact positions A4-D4 contacted by the rope wheels A-D. The contact positions A4-D4 are showed in FIG. 7d, showing the rope 2 in straight shape, as well as in FIG. 5 presenting the contact positions A4-D4 in numerical form as a distance L along the rope length from the aforementioned rope reference position.

FIGS. 5, 6 and 7e show all the contact positions A1, A2, A3, A4, B1, B2, B3, B4, C1, C2, C3, C4, D1, D2, D3 and D4 arranged in order of magnitude of their distance L from the aforementioned reference position. These Figures thus show the positions of the rope 2, per each landing 3a-3d, which are contacted by rope wheels A-D when the car 1 is at the landing 3a-3d.

FIGS. 6 and 7e moreover show discretization points Dp1-Dp15, wherein each said discretization point Dp1-Dp15 is a point within a rope portion p1-p15 extending between successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4 of the rope 2. Here successive contact positions are contact positions, which are next to each other in said order of magnitude of their distance L from the aforementioned reference position. The aforementioned rope portions p1-p15 are showed in FIG. 7e. The rope portions p1-p15 are also referred to as discretization portions.

An embodiment of the method of monitoring condition of a rope 2 of an elevator arrangement 100 comprises monitoring by the computer system 4 an amount of bendings of each discretization point Dp1-Dp15 [or alternatively of each discretization portion p1-p15] around a rope wheel A,B,C,D during elevator use.

The discretization points Dp1-Dp15 [or discretization portions p1-p15 respectively] have here been chosen carefully from an infinite number of possible points [or portions respectively] the aim being that they represent the most important locations of the rope 2 whose amount of bendings is most relevant and critical to be monitored. The number of discretization points/portions is advantageously relatively small so that the method can be kept simple and light.

In the following, a solution utilizing discretization points has been described by way of many examples. As an alternative to monitoring amount of bendings of points, i.e. the discretization points, in the method alternatively bendings of larger rope parts of the rope can be monitored, namely discretization portions.

As described above, here, each said discretization point Dp1-Dp15 is a point within a rope portion p1-p15 extending between successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4 of the rope, and said contact positions of the rope 2 include the positions of the rope 2, per each landing 3a-3d, which are contacted by rope wheels A-D when the car 1 is at the landing 3a-3d.

The amount of bendings of each discretization point Dp1-Dp15 is indicated by a bending value associated with the discretization point Dp1-Dp15 [or discretization portion p1-p15 respectively] in question. Thus, in the method amount of bendings in each discretization point Dp1-Dp15, as showed in FIG. 7, is monitored.

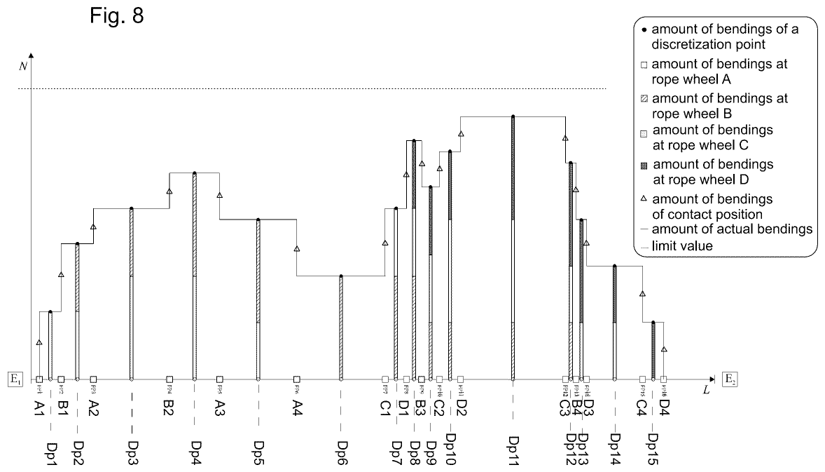

Thus, the points Dp1-Dp15 are regarded as the important points the bendings of which should be monitored. The reason is that they are likely most critical points of the rope 2 in terms of the amount of bendings they have experienced during elevator use. Namely, one of these points is likely the point of the whole rope 2 which has experienced the highest number of bendings. FIG. 8 shows that bendings of discretization points Dp1-Dp15 are equal to the actual bendings curve. The method using only fifteen discretization points brings out that discretization point Dp11 has experienced the greatest amount of bendings and the indicated value corresponds to the actual amount illustrated by solid line in the FIG. 8. Here, the simplistic method has indicated correctly the amount of maximum bendings as well as the point which has experienced the maximum amount of bendings.

Elsewhere in the application, different ways of generating the bending values of the discretization points Dp1-Dp15 have been described. In most simple way, the bending values can be accumulated values generated by counting the bendings of each discretization point Dp1-Dp15. There are multiple different known methods for counting bendings of a point of a rope or of a portion of a rope. This can be simply done by counting how many times the point under inspection meets a rim of a rope wheel.

The method comprises, in particular before said monitoring by the computer system 4 an amount of bendings of each discretization point Dp1-Dp15 and/or of each discretization portion around a rope wheel A,B,C,D during elevator use,
determining contact positions A1, A2, A3, A4, B1, B2, B3, B4, C1, C2, C3, C4, D1, D2, D3 and D4 of the rope 2, comprising determining per each landing 3a,3b,3c,3d, the positions A1, A2, A3, A4, B1, B2, B3, B4, C1, C2, C3, C4, D1, D2, D3 and D4 of the rope 2, which are contacted by rope wheels A,B,C,D when the car 1 is at the landing 3a,3b,3c,3d; and
determining discretization points Dp1-Dp15 of the rope [or discretization portions p1-p15 of the rope 2 respectively], such that each discretization point is a point within a rope portion p1-p15 extending between successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4 [or each discretization portion p1-p15 is a rope portion extending between successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4 respectively].

The contact positions A1, A2, A3, A4, B1, B2, B3, B4, C1, C2, C3, C4, D1, D2, D3 and D4 are determined such in particular that there is only one contact position per the length of contact between the rope and the rope wheel. It is advantageous and simple that even though there is some contact length between the rope 2 and each rope wheel A-D, it is relatively short, for example the rope length being dozens or hundreds of meters, and so each contact position can be handled point-like in the method.

Generally, the contact positions and/or said discretization points Dp1-Dp15 are preferably presented and/or processed as a value representing distances L of the contact positions and/or said discretization points Dp1-Dp15 along the rope length from a rope reference position, said rope reference position preferably being an end point of the rope or the contact point which is first from an end point of the rope.

The determining of contact positions A1, A2, A3, A4, B1, B2, B3, B4, C1, C2, C3, C4, D1, D2, D3 and D4 of the rope 2 can be performed experimentally by driving the car to each landing (as illustrated in FIGS. 1-4) and marking the contact positions per each landing. This can also be done theoretically on by calculation since all the dimensions of the elevator are known. For example, in the case of 2:1 elevator arrangement of FIG. 1 determining of contact positions A1, A2, A3, A4, B1, B2, B3, B4, C1, C2, C3, C4, D1, D2, D3 and D4 of the rope 2 can be performed by calculation based on known distances between landings (3a-3b=2.56 m, 3a-3c=8.52 m, 3a-3d=12.18 m) and known distance between car rope wheels and known suspension ratio. In the case of elevator arrangement of FIG. 1, for example contact positions can be calculated as follows:

$$\begin{matrix}{L}_{dpcwt} = x \times Travel & Rope wheel A\end{matrix} \qquad ( 1 )$$

$$\begin{matrix}{L}_{tr} = 2 x \times Travel + {L}_{1 cwt} & Rope wheel B\end{matrix} \qquad ( 2 )$$

$$\begin{matrix}{L}_{dp 1 car} = ( x + 1 ) \times Travel + {L}_{1 cwt} + {L}_{1 car} & Rope wheel C\end{matrix} \qquad ( 3 )$$

$$\begin{matrix}{L}_{dp 2 car} = ( x + 1 ) \times Travel + {L}_{1 cwt} + {L}_{1 car} + {L}_{p 1 car} & Rope wheel D\end{matrix} \qquad ( 4 )$$

X represents in the equations 1-4 the relative car position (0, 0.21, 0.70 or 1) when at landings. In equation (2) the factor 2 comes from the hoisting ratio being 2:1 in the elevator of the example. The values of contact positions thus obtained can be put on a table.

Table below shows an example of how the distance L of a position contacted by a rope wheel along the rope length from a rope reference position can be gathered, said rope reference position being in this case the contact position A1.

| | Distance | | L [m] | | | |
|---|---|---|---|---|---|---|
| Landing | (from 3a) | x | A | B | C | D |
| 3a | 0.00 | 0.00 | 0.00 | 1.04 | 16.37 | 17.37 |
| 3b | 2.56 | 0.21 | 2.56 | 6.16 | 18.93 | 19.93 |
| 3c | 8.52 | 0.70 | 8.52 | 18.09 | 24.89 | 25.89 |
| 3d | 12.18 | 1.00 | 12.18 | 25.39 | 28.55 | 29.55 |

The gathered contact positions can then be rearranged in order of magnitude as illustrated in FIG. 5.

The determining discretization points Dp1-Dp15 of the rope respectively [or discretization portions p1-p15 of the rope respectively] comprises arranging the values of the contact positions A1, A2, A3, A4, B1, B2, B3, B4, C1, C2, C3, C4, D1, D2, D3 and D4 in order of magnitude of their distance L from a reference position. This order is shown in FIG. 5 for instance. Thereafter the method comprises selecting a value of each discretization point Dp1-Dp15 such that it is between values of successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4, or respectively selecting value range of each discretization portion p1-p15 such that the range is between values of successive contact positions should the alternative embodiment be applied. The determining discretization points Dp1-Dp15 or discretization portions p1-p15 of the rope 2 preferably comprises storing a value of each discretization point Dp1-Dp15 [or a value range respectively] in a memory position.

Preferably, each said discretization point Dp1-Dp15 is determined such that it is within central third of the rope portion p1-p15 extending between successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4, most preferably the middle point of the portion p1-p15, as can be seen in FIG. 6 where each said discretization point Dp; Dp1-Dp15 is halfway between successive contact positions.

The aforementioned monitoring by the computer system 4 an amount of bendings of each discretization point Dp1-Dp15 and/or of each discretization portion around a rope wheel A,B,C,D during elevator use preferably comprises
comparing, in particular by the computer system 4 for monitoring condition of a rope 2, each bending value with at least one limit value; and
performing, in particular by the computer system 4 for monitoring condition of a rope, one or more actions if any of the bending values meets a limit value.

This is illustrated in FIG. 8, where a broken line represents a limit value. When a bending value meets this limit value, this triggers said one or more actions, which is advantageous since this can be used as an alarm. The actions can be chosen appropriately, and the one or more actions preferably comprises generating an alarm signal.

For facilitating storing of bending values of specific discretization points Dp1-Dp15 [or a discretization portion p1-p15 respectively], the method comprises, in particular before said monitoring by the computer system 4 an amount of bendings, associating with each said discretization point Dp1-Dp15 [or a discretization portion p1-p15 respectively] a different memory position in a memory for storing a bending value of a discretization point Dp1-Dp15 [or a discretization portion respectively].

The monitoring preferably comprises counting or computing a bending value for each discretization point Dp1-Dp15 and/or of each discretization portion.

The counting is preferably performed during elevator use, e.g. continuously. Thus, it reacts swiftly to according to the prevailing situation and updated amount of bendings. The computing is preferably performed intermittently or after a period of elevator use, e.g. based on stored elevator journey data. The computing offers an option for taking the method into use in an elevator arrangement that has been already in use, provided that the journeys thereof are stored or in some way available. Thus, the method can be taken into use in an elevator that has been in use for some time, as well.

Preferably, the counting or the computing a bending value comprises increasing a bending value in a memory position which is associated with a discretization point Dp1-Dp15 [or a discretization portion respectively], by a value, preferably 1, per each time said discretization point Dp1-Dp15 or a discretization portion respectively passes, or has passed, around a rope wheel during a car journey from one landing to another.

An increase by value 1 is preferable when there is no need to differentiate rope wheel bends, but if there are rope wheels at which the rope is bent with a substantially small diameter, it may be appropriate to give more weight in the method for bendings at those rope wheels. This can be easily done such that the increase is greater than 1 per each time said discretization point Dp1-Dp15 or a discretization portion respectively passes, or has passed, around such a small diameter rope wheel during a car journey from one landing to another. Thus, the solution can take into account differences in bending diameter. Correspondingly, it is possible to give little weight to a rope wheel at which the rope is bent with a substantially large diameter. If there is such a rope wheel, the increase is preferably smaller than 1 per each time said discretization point Dp1-Dp15 [or a discretization portion respectively] passes, or has passed, around such a large diameter rope wheel during a car journey from one landing to another. Thus, taking into account the bending diameter is further facilitated.

Generally, said increasing can be performed at any suitable moment before, during or after the journey in question. In the case where the counting a bending value is performed during elevator use, e.g. continuously, most preferably each increasing associated with a journey is performed before starting a journey following the journey in question.

The method preferably comprises determining for each car journey which discretization points Dp1-Dp15 [or discretization portions p1-p15 respectively] pass, or have passed, around a rope wheel during the car journey in question and/or the memory positions the values of which are to be increased. The determining can be performed in alternative ways, examples of which are described below.

In a first embodiment, of a simplistic kind, said determining for each car journey the memory positions the values of which are to be increased comprises retrieving from a database, such as a table, information indicating the memory positions the values of which are to be increased for the journey in question. The database then preferably comprises information indicating the memory positions the values of which are to be increased for each possible journey variation. Thus, for each journey variation, there can be a predefined a group of memory positions to be increased per each occurrence of that journey, i.e. which discretization points experience bendings during the journey. The journey variations include per each landing a journey from that landing to each other landing. For example, for landing 3a the journey variations are 3a→3b, 3a→3c, 3a→3d, and for landing 3b the journey variations are 3b→3a, 3b→3c, 3b→3d, and for landing 3c the journey variations are 3c→3a, 3c→3b, 3c→d and for landing 4 the journey variations are 3d→3a, 3d→3b, 3d→3c. This provides a simple solution which can be light to process by the computer system. The members of said a group of memory positions to be increased per each occurrence of a specific journey variation, i.e. which discretization points experience bendings during the journey, can be determined by calculation.

In a second embodiment, which is more complex but well suitable for elevators having any amount of landings, said determining for each car journey which discretization points Dp1-Dp15 [or discretization portions p1-p15 respectively] pass, or have passed, around a rope wheel during the car journey in question comprises computing which discretization points Dp1-Dp15 [or discretization portions p1-p15 respectively] pass, or have passed, around a rope wheel during the car journey in question. This computing can be performed e.g. as described below concerning a journey.
1. The start landing and the end landing of the journey are known.
2. The wheel positions, when at the start landing, are calculated by equations 1-4 placing x_start therein, which is 0,0.21,0.70 or 1.0 depending on from which landing the journey starts. As a result L_dpcwt_start, L_tr_start, L_dp1car_start and L_dp2car_start are obtained.
3. The wheel positions, when at the end landing, are calculated by equations 1-4 placing x_end therein, which is 0,0.21,0.70 or 1.0 depending on the destination landing of the journey. As a result L_dpcwt_end, L_tr_end, L_dp1car_end ja L_dp2car_end are obtained.
4. Each discretization point is compared with the calculated wheel positions. Below, this is shown for Dp11:
   If min (L_dpcwt_start, L_dpcwt_end)<=L_Dp11<=max (L_dpcwt_start, L_dpcwt_end), then N (Dp11)+=1
   If min (L_tr_start, L_tr_end)<=L_Dp11<=max (L_tr_start, L_tr_end), then N (Dp11)+=1
   If min (L_dp1car_start, L_dp1car_end)<=L_Dp11<=max (L_dp1car_start, L_dp1car_end), then N (Dp11)+=1
   If min (L_dp2car_start, L_dp2car_end)<=L_Dp11<=max (L_dp2car_start, L_dp2car_end), then N (Dp11)+=1

Min and max-operators used above provide that the equations work even when the wheel position (L) is greater in start landing than end landing. The equations thus work in both driving directions.

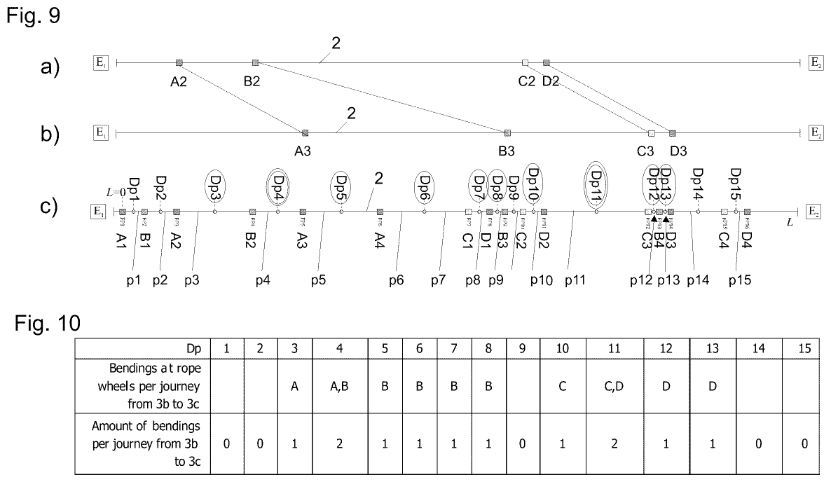

FIG. 9 illustrates drawings a), b) and c) corresponding to parts b), c) and e) of FIG. 7, but showing by broken line, from where and to where, the rope wheels A,B,C,D have rotated along the rope 2 in a case where the journey is from landing 3b to landing 3c. The elevator of FIG. 1 is suspended by 2:1 ratio and the landings are of non-constant distance from each other which complicate the system. Due to the ratio, as can be seen, the traction wheel B has rotated along the rope 2 a longer distance than the other rope wheels. The traction wheel B has rotated past Dp4,Dp5,Dp6,Dp7 and Dp8. The rope wheel A has rotated past Dp3 and Dp4. The rope wheel C has rotated past Dp10 and Dp11. The rope wheel D has rotated past Dp11, Dp12 and Dp13. This has been illustrated in table of FIG. 10. This kind of table is simple to create per each journey variation and can provide the information indicating the memory positions the values of which are to be increased for the journey in question in this case journey 3b→3c. The table is simple to create based on schematics as illustrated in FIG. 9. In FIG. 9, the discretization points [or discretization portions respectively] that have experienced a bending during the journey in question have been encircled once per each bending.

Generally, the method preferably, although not necessarily, comprises providing an estimate for when repair or a rope change is needed, presented as the estimated time remaining until the event in question or as the estimated moment of the event in question. This preferably comprises calculating the difference between the amount of bendings of a discretization point or portion respectively having the greatest amount of bendings and a limit value of bendings, e.g. maximal allowed amount of bendings of a single point or portion of the rope, and calculating an estimate when the amount of bendings of the discretization point or portion respectively reaches the limit value based on growth rate of the amount of bendings of said discretization point or portion respectively. The method preferably moreover comprises presenting based on said calculation a signal indicating such an estimate in a user interface for thus informing the user of the estimate. This way the user of the interface, such as the elevator maintenance person, can anticipate and prepare for the event.

In the following details of the elevator arrangement 100 of FIG. 1 are further specified. The elevator arrangement 100 comprises an elevator car 1; at least one rope 2 connected to the elevator car 1; a plurality of landings 3; and a plurality of rope wheels A,B,C,D around which the rope 2 passes; and a computer system 4 for monitoring condition of the rope 2, the computer system 4 comprising a memory having plurality of memory positions for storing a bending value of a discretization point Dp1-Dp15 [or a discretization portion p1-p15 respectively], wherein with each of said memory positions a discretization point Dp1-Dp15 [or a discretization portion p1-p15 respectively] has been associated. The computer system 4 is configured to monitor an amount of bendings of each discretization point Dp1-Dp15 and/or of each discretization portion p1-p15 around a rope wheel A,B,C,D during elevator use, the amount of bendings of each discretization point Dp1-Dp15 and/or of each discretization portion p1-p15 being indicated by a bending value associated with the discretization point Dp1-Dp15 and/or discretization portion p1-p15 in question. Each said discretization point Dp1-Dp15 is a point within a rope portion p1-p15 extending between successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4 of the rope 2, and respectively, each said discretization portion p1-p15 is a rope portion p1-p15 extending between successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4 of the rope 2. Said contact positions A1-D4 of the rope include the positions of the rope 2, per each landing 3a-3d, which are contacted by rope wheels A-D when the car 1 is at the landing 3a-3d. The computer system 4 is configured to compare each bending value with at least one limit value; and to perform one or more actions if any of the bending values meets a limit value. The computer system 4 is configured to count or compute a bending value for each discretization point Dp1-Dp15 and/or for each discretization portion p1-p15.

The computer system 4 is configured to perform said counting during elevator use, e.g. continuously, or to perform said computing intermittently or at least after a period of elevator use, e.g. based on stored elevator journey data.

The computer system 4 is configured to perform said counting and/or computing by a computer program stored in the memory and running in said computer system 4. The computer system 4 is configured to, in particular by the computer program, to increase a bending value in a memory position which is associated with a discretization point Dp1-Dp15 [or a discretization portion p1-p15 respectively], by a value, preferably 1, per each time said discretization point Dp1-Dp15 [or a discretization portion p1-p15 respectively] passes, or has passed, around a rope wheel A,B,C,D during a car journey from one landing to another.

The computer system 4 is configured to, in particular by a computer program, determine for each car journey which discretization points Dp1-Dp15 [or a discretization portion p1-p15 respectively] respectively pass around a rope wheel A,B,C,D during the car journey in question and/or the memory positions the values of which are to be increased. The computer system 4 is preferably configured to perform these steps as described in context of the method earlier.

As mentioned, FIG. 8 illustrates schematically an example of amount of bendings of different discretization points Dp1-Dp15, in particular of the elevator arrangement 100 which has been in use for a period. FIG. 8 also illustrates the amount of bendings of contact positions for comparison. It is visible that the amount of bendings of contact positions is generally lower than the amount of bendings of the discretization points as well as lower than the amount of actual bendings. Thus, it can be deduced that the discretization points as determined as described earlier above are critical to be monitored and bring out if a point of the rope is about to reach a critical amount of bendings. FIG. 8 also differentiates per each discretization point how large portion of the bending is caused by each rope wheel A-D.

Generally, to meet very different elevator arrangements it may be that in some elevator arrangement, it is advantageous to consider a pair of very closely positioned rope wheels exceptionally one rope wheel. For example, if the elevator arrangement happens to have two rope wheels very close to each other, such as so close that the rims thereof are less than 1 meter apart, it is an alternative that the two rope wheels are considered exceptionally in the method (and an arrangement implementing it) as only one rope wheel which simplifies the method monitoring. In this case, bending around such a pair of rope wheels produces an increase more than 1, such as preferably 2. In such a case, also the contact position can be regarded to be a point, in particular a single point, within the length of contact between the rope and the rope wheels and the rope span extending between their rims.

Generally, the elevator arrangement 100 can comprise more than one of said ropes 2 arranged in parallel to pass along a same route and to form a roping. In this case each rope 2 is preferably monitored in a similar manner. In the application monitoring each individual rope of said at least one ropes 2 is described.

Generally, the suspension ratio of the car 4 and counterweight 5 can be 2:1 as illustrated in Figures. However, alternatively some other suspension ratio could be used, such as 1:1, or 4:1 for example, or any combination of suspension ratios mentioned.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. A method of monitoring condition of a rope of an elevator arrangement, which elevator arrangement comprises an elevator car;
at least one rope connected to the elevator car;
a plurality of landings; and
a plurality of rope wheels around which the rope passes; and
a computer system for monitoring condition of the rope;
the method comprising
monitoring by the computer system an amount of bendings of each discretization point and/or of each discretization portion around a rope wheel during elevator use, the amount of bendings of each discretization point and/or of each discretization portion being indicated by a bending value associated with the discretization point and/or discretization portion in question;
wherein each said discretization point is a point within a rope portion extending between successive contact positions of the rope, and respectively, each said discretization portion is a rope portion extending between successive contact positions of the rope; and
wherein said contact positions of the rope include the positions of the rope, per each landing, which are contacted by rope wheels when the car is at the landing.

2. A method according to claim 1, wherein the method comprises:
determining contact positions of the rope, comprising determining per each landing, the positions of the rope, which are contacted by rope wheels when the car is at the landing; and
determining discretization points or discretization portions of the rope, such that each discretization point is a point within a rope portion extending between successive contact positions or respectively each discretization portion is a rope portion extending between successive contact positions.

3. A method according to claim 1, wherein the monitoring comprises
comparing, in particular by the computer system for monitoring condition of a rope, each bending value with at least one limit value; and
performing, in particular by a computer system for monitoring condition of a rope, one or more actions if any of the bending values meets a limit value.

4. A method according to claim 1, wherein the method comprises associating with each said discretization point, or a discretization portion respectively, a different memory position in a memory for storing a bending value of a discretization point or a discretization portion.

5. A method according to claim 1, wherein the monitoring comprises counting or computing a bending value for each discretization point and/or of each discretization portion.

6. A method according to claim 1, wherein the method, in particular the counting or the computing a bending value, comprises increasing a bending value in a memory position which is associated with a discretization point or a discretization portion respectively, by a value, preferably 1, per each time said discretization point or a discretization portion respectively passes, or has passed, around a rope wheel during a car journey from one landing to another.

7. A method according to claim 1, wherein the method comprises determining for each car journey which discretization points or discretization portions respectively pass, or have passed, around a rope wheel during the car journey in question and/or determining for each car journey the memory positions the values of which are to be increased.

8. A method according to claim 7, wherein
said determining for each car journey the memory positions the values of which are to be increased comprises retrieving from a database, such as a table, information indicating the memory positions the values of which are to be increased for the journey in question, the database preferably comprising information indicating the memory positions the values of which are to be increased for each possible journey variation; or
said determining for each car journey which discretization points or discretization portions respectively pass, or have passed, around a rope wheel, during the car journey in question, is performed by computing.

9. A method according to claim 1, wherein the contact positions and/or said discretization points are presented and/or processed as a value representing distances of the contact positions and/or said discretization points along the rope length from a rope reference position, said rope reference position preferably being an end point of the rope or the contact point which is first from an end point of the rope.

10. A method according to claim 1, wherein each said discretization point is within central third of the rope portion extending between successive contact positions, most preferably the middle point of the portion.

11. A method according to claim 1, wherein the determining discretization points or discretization portions of the rope comprises arranging the values of the contact positions in order of magnitude, and selecting a value of each discretization point such that it is between values of successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4, or respectively selecting value range of each discretization portion such that the range is between values of successive contact positions A1, B1; B1, A2; A2, B2; B2, A3; A3, A4; A4, C1; C1, D1; D1, B3; B3, C2; C2, D2; D2, C3; C3, B4; B4, D3; D3, C4; C4, D4.

12. An elevator arrangement comprising an elevator car;
at least one rope connected to the elevator car;
a plurality of landings; and
a plurality of rope wheels around which the rope passes; and
a computer system for monitoring condition of the rope, the computer system comprising a memory having plurality of memory positions for storing a bending value of a discretization point or a discretization portion, wherein with each of said memory positions a discretization portion or a discretization point has been associated, wherein the computer system is configured to
monitor an amount of bendings of each discretization point and/or of each discretization portion around a rope wheel during elevator use, the amount of bendings of each discretization point and/or of each discretization portion being indicated by a bending value associated with the discretization point and/or discretization portion in question;
wherein each said discretization point is a point within a rope portion extending between successive contact positions of the rope, and respectively, each said discretization portion is a rope portion extending between successive contact positions of the rope; and
wherein said contact positions of the rope include the positions of the rope, per each landing, which are contacted by rope wheels when the car is at the landing.

13. An elevator arrangement according to claim 12, wherein the computer system is configured to
compare each bending value with at least one limit value; and
perform one or more actions if any of the bending values meets a limit value.

14. An elevator arrangement according to claim 12, wherein the computer system is configured to count or compute a bending value for each discretization point and/or for each discretization portion.

15. An elevator arrangement according to claim 12, wherein
the computer system is configured to, in particular by the computer program, to increase a bending value in a memory position which is associated with a discretization point or a discretization portion respectively, by a value, preferably 1, per each time said discretization point or a discretization portion respectively, passes, or has passed, around a rope wheel during a car journey from one landing to another; and/or
the computer system is configured to determine for each car journey, in particular by a computer program, which discretization points or discretization portions respectively, pass or have passed, around a rope wheel during the car journey in question and/or the memory positions the values of which are to be increased.
